(19) United States
(12) Patent Application Publication
(10) Pub. No.: US 2004/0083836 A1
(43) Pub. Date: May 6, 2004

(54) Continuously variable mechanical transmission

(75) Inventor: Bret J. Park, South Jordan, UT (US)

Correspondence Address: KARL R CANNON, PO BOX 1909, SANDY, UT, 84091, US

(73) Assignee: TransVantage, L.L.C.

(21) Appl. No.: 10/289,828

(22) Filed: Nov. 6, 2002

(51) Int. Cl. F16H 29/04

(52) U.S. Cl. 74/117

(57) ABSTRACT

A variable-ratio transmission device includes a crankshaft for attachment to a first rotational member at an axis of rotation. The crankshaft may be angled such that a portion of the crankshaft is offset a radial distance from the axis of rotation. A connecting arm may be attached to the crankshaft in a manner such that the connecting arm can be moved along the length of the crankshaft. The connecting arm may be attached to an second rotational member such that as the crankshaft is rotated, the connecting arm causes the second rotational member to rotate back and forth. A ratio of movement between the first rotational member and the second rotational member can be adjusted by moving the connecting arm along the length of the crankshaft to thereby alter the radial distance the connecting arm is moved during rotation of the crankshaft.

### BACKGROUND OF THE INVENTION

1. The Field of the Invention

The present invention relates generally to transmission devices, and more particularly, but not necessarily entirely, to a variable-ratio transmission device.

2. Description of Related Art

Transmission devices are well known in the field of motorized vehicles for converting and transmitting the force generated by an engine to an output shaft. It is known to make efficient use of the motor power by adjusting the gear ratio between the input and output shafts responsive to variation in loads on the output shaft, or on the input shaft. For example, a higher gear ratio often provides a more efficient transfer of force for larger loads on the output shaft. Conversely, a lower gear ratio often suffices for lesser loads on the output shaft.

The need to optimize the motor power by varying the gear ratio has motivated the development of many different transmission devices capable of shifting between gear ratios. The standard transmission is known in the field to permit an operator to shift between various gear ratios by operating a hand-shift lever in conjunction with a foot clutch. Automatic transmissions have been developed which accomplish an automatic shifting between gear ratios responsive to increases and decreases in load on the output shaft.

Another approach to vehicle transmissions is the concept of a continuously variable transmission, which automakers have attempted for years to develop. It is thought that energy transfer between the motor and the output shaft can be further optimized by providing an infinite range of gear ratios between the minimum and maximum gear ratios, instead of merely four or five different gear ratios. This idea is a good one, since variation in load on the output shaft tends to increase and decrease gradually and continuously. Indeed, it stands to reason that provision of an optimal gear ratio for each and every load variation on the output shaft would maximize the efficiency of the vehicle. However, there have been many practical difficulties with the prior art transmission devices which offer continuously variable gear ratios.

For example, U.S. Pat. No. 4,936,155 to Gogins discloses a variable transmission device. The transmission has an input shaft with a lobed cam slidably splined on the shaft. A plurality of cam followers mechanically engage the cam as it is rotated. The cam followers are connected to an output shaft through a one-way clutch mechanism. The cam followers require a biasing means to maintain contact with the cam so that as the cam is rotated, reciprocating motion is imparted through the cam followers to the output shaft. The biasing means of the cam followers are prone to wear and failure due to the repeated motion of the cam followers. Accordingly, maintenance of the transmission may be burdensome. Moreover, rotation of the cam may cause unwanted vibration to the transmission.

The prior art is thus characterized by several disadvantages that are addressed by the present invention. The present invention minimizes, and in some aspects eliminates, the above-mentioned failures, and other problems, by utilizing the methods and structural features described herein.

The features and advantages of the invention will be set forth in the description which follows, and in part will be apparent from the description, or may be learned by the practice of the invention without undue experimentation. The features and advantages of the invention may be realized and obtained by means of the instruments and combinations particularly pointed out in the appended claims.

### BRIEF DESCRIPTION OF THE DRAWINGS

The features and advantages of the invention will become apparent from a consideration of the subsequent detailed description presented in connection with the accompanying drawings in which:

FIG. 1 is a perspective view of a transmission in accordance with the principles of the present invention;

FIG. 1a is a break-away cross sectional view of braking means attached to the flywheel of FIG. 1;

FIG. 2a is a side view of a transmission device;

FIG. 2b is a side view of an alternative embodiment of the transmission device;

FIG. 2c is a side view of an additional alternative embodiment of the transmission device;

FIG. 3 is a perspective view of the transmission device of FIG. 2a;

FIG. 4a is a perspective view of a crankshaft in accordance with the principles of the present invention;

FIG. 4b is a perspective view of an additional embodiment of the crankshaft;

FIG. 4c is a perspective view of a further embodiment of the crankshaft;

FIG. 4d is a perspective view of a an additional embodiment of the crankshaft;

FIG. 5 is a perspective view of a connecting arm of FIGS. 1-3;

FIG. 6a is a perspective view of a further embodiment of a portion of the transmission device;

FIG. 6b is an exploded perspective view of the connecting arm and bearing of FIG. 6a;

FIG. 7a is a perspective view of a transmission with a crankshaft operating a rack and pinion system;

FIG. 7b is a top view of the transmission of FIG. 7a with the connecting arm positioned at a low movement ratio position;

FIG. 7c is a perspective view of the transmission of FIGS. 7a-7b with the connecting arm in an intermediate movement ratio position;

FIG. 7d is a top view of the transmission of FIGS. 7a-7c with the connecting arm positioned in a high ratio movement position;

FIG. 8 is a break-away perspective view of a transmission device operating a chain and sprocket;

FIG. 9 is a perspective view of a flex coupling device;

FIG. 10 is a break-away side view of an alternative crankshaft having multiple journal portions and multiple connecting arms;

FIG. 11 is a break-away perspective view of an alternative embodiment transmission having a counterbalance shaft;

FIG. 12a is a front view of a gear portion of a unidirectional clutch for use with the transmission of the present invention;

FIG. 12b is a front view of a notch plate used with the gear portion of FIG. 12a;

FIG. 12c is a break-away cross-sectional view of the assembled gear portion and notch plate of FIGS. 12a and 12b;

FIG. 13 is a cross-sectional view of a unidirectional sprag clutch for use with the transmission of the present invention;

FIG. 14 is a cross-sectional view of a unidirectional roller clutch for use with the transmission of the present invention;

FIG. 15 is a cross-sectional view of a unidirectional ratcheting clutch for use with the transmission of the present invention;

FIG. 16 is a schematic view of a plurality of transmissions used in a compression braking, non-freewheeling device;

FIG. 17 is an end view of a counter weight having adjustable weights;

FIG. 18a is a cross-section of an embodiment of the journal portion;

FIG. 18b is a cross-section of an alternative oblong embodiment journal portion;

FIG. 18c is a cross-section of an alternative triangular embodiment journal portion;

FIG. 18d is a cross-section of an alternative square embodiment journal portion;

FIG. 18e is a cross-section of an alternative embodiment rectangular journal portion; and

FIG. 18f is a cross-section of an alternative embodiment “I” beam journal portion.

### DETAILED DESCRIPTION OF THE INVENTION

For the purposes of promoting an understanding of the principles in accordance with the invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed.

It must be noted that, as used in this specification and the appended claims, the singular forms “a,” “an,” and “the” include plural referents unless the context clearly dictates otherwise. Moreover, as used herein, the terms “comprising,” “including,” “containing,” “characterized by,” and grammatical equivalents thereof are inclusive or open-ended terms that do not exclude additional, unrecited elements or method steps.

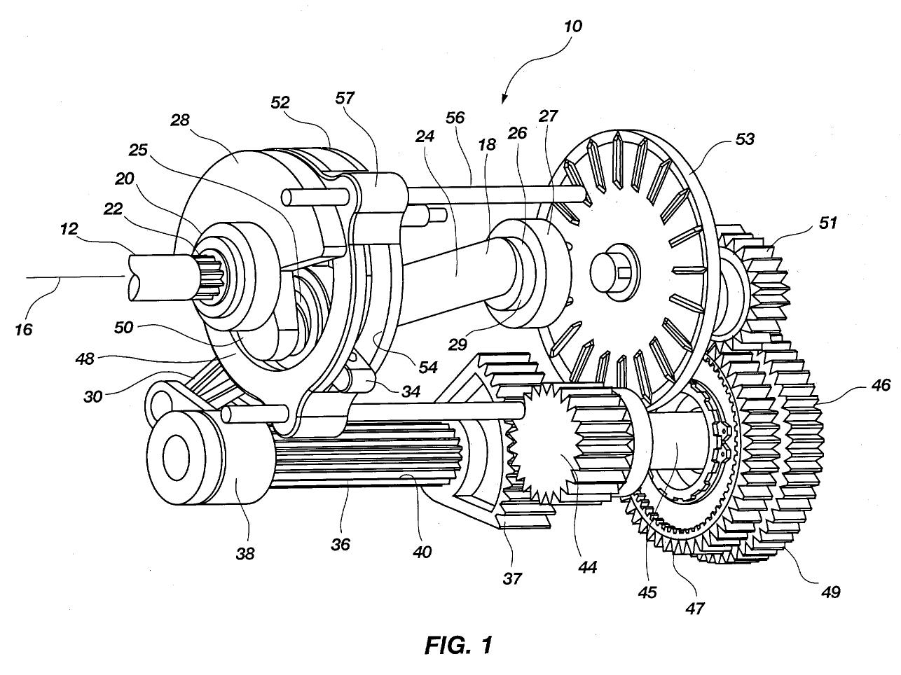

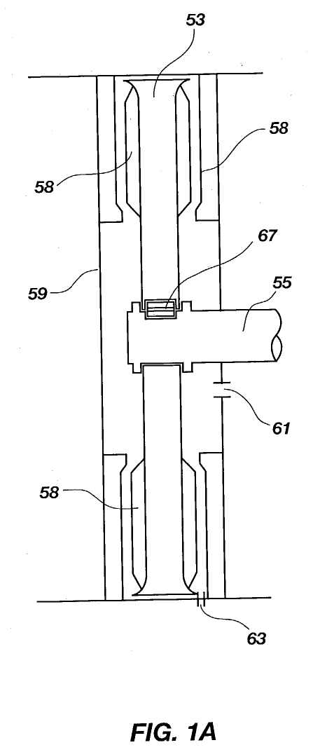

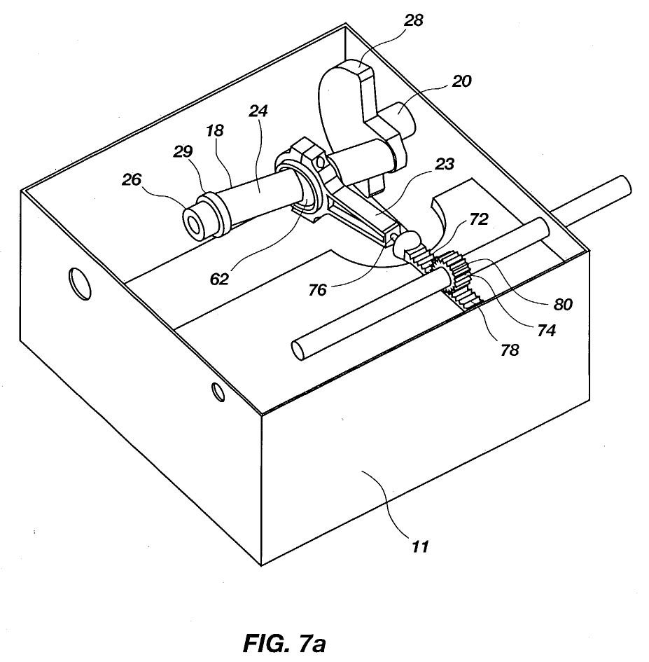

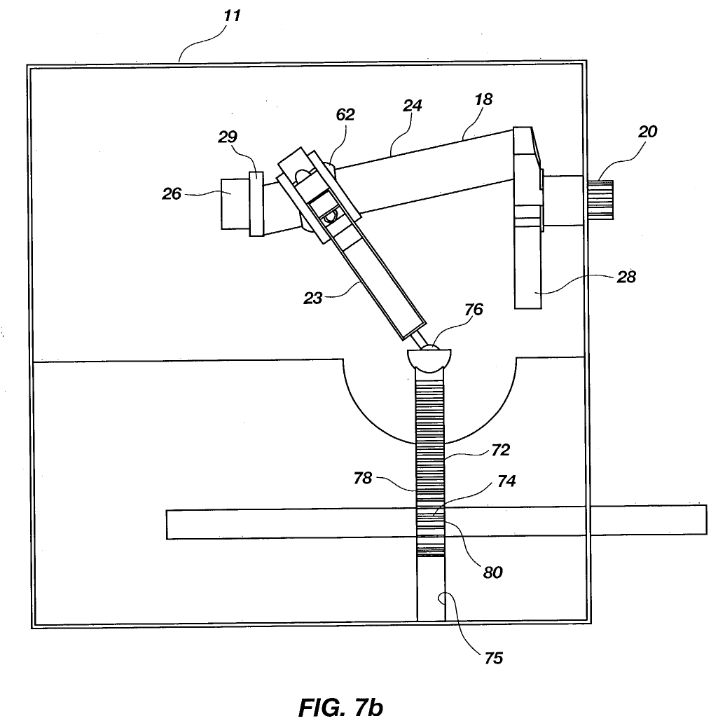

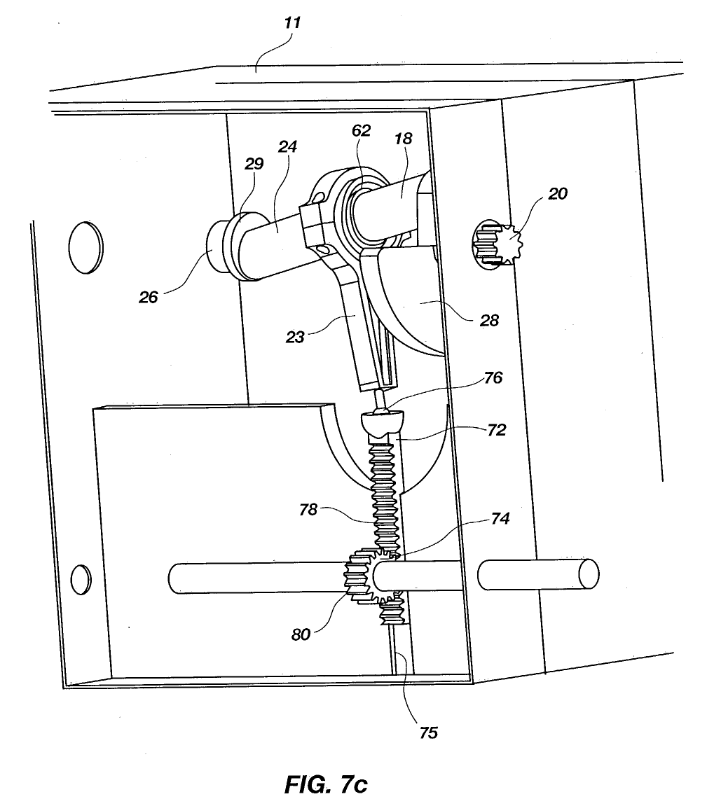

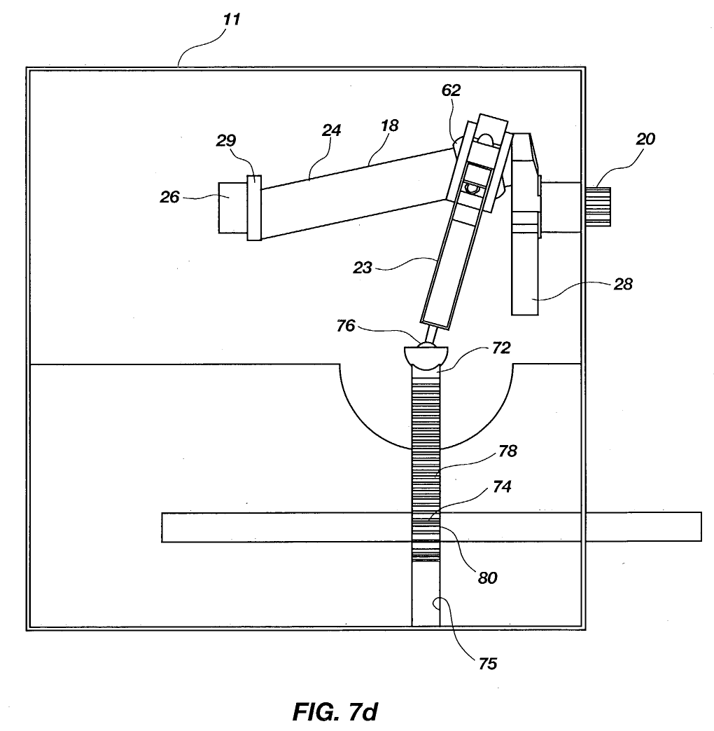

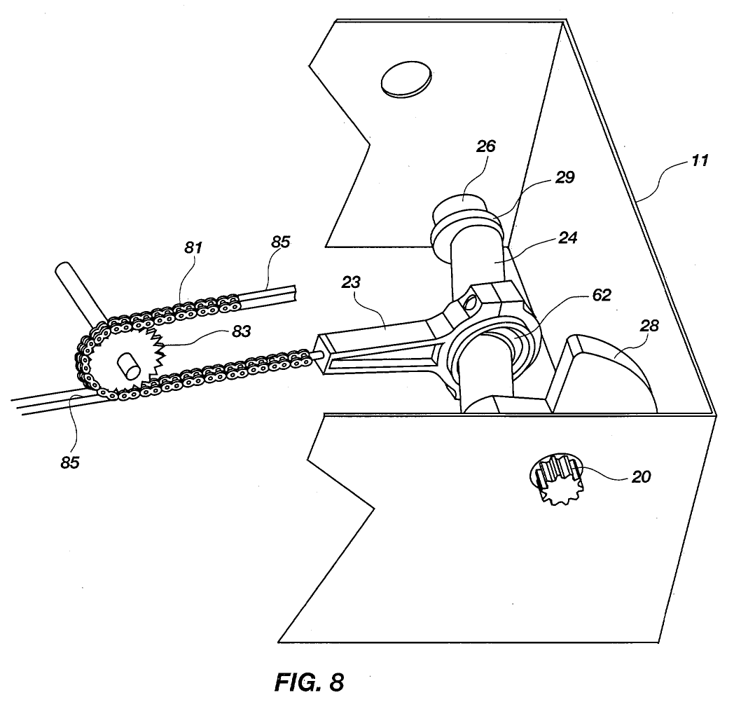

Applicant has discovered a new transmission device capable of transmitting force while varying gear ratios during movement of the gears. Referring now to FIG. 1, a perspective view is shown of a transmission, designated generally at 10. The transmission 10 may be positioned in a housing 11 (FIGS. 7-8) of any variety known in the art for supporting or covering the transmission 10. The transmission 10 may be attached to a first rotational member 12, of any of various different configurations such as a shaft, crank arm, disc, wheel, plate, or gear, for example. The first rotational member 12 may be configured for attachment to a means (not shown) for rotating the first rotational member 12 about an axis of rotation 16. The means for rotating the first rotational member 12 may be an engine, for example, or any other suitable means known in the art for rotating the first rotational member 12.

A crankshaft 18 may be attached to the first rotational member 12 at a point on the axis of rotation 16. As shown in FIGS. 1-4, The crankshaft 18 may include a first end portion 20 for attachment to the first rotational member 12, and a second end portion 26 disposed on the crankshaft 18 opposite the first end portion 20. The second end portion 26 may be positioned coaxially with the first end portion 20 along the axis of rotation 16.

Means 22 for attaching the crankshaft 18 to the first rotational member 12 may be located on the first end 20. The means 22 for attaching the crankshaft 18 to the first rotational member 12 may include any suitable attachment means, such as splines, threads, welding, fasteners, a friction or interference attachment mechanism, or any other suitable means known to those skilled in the art.

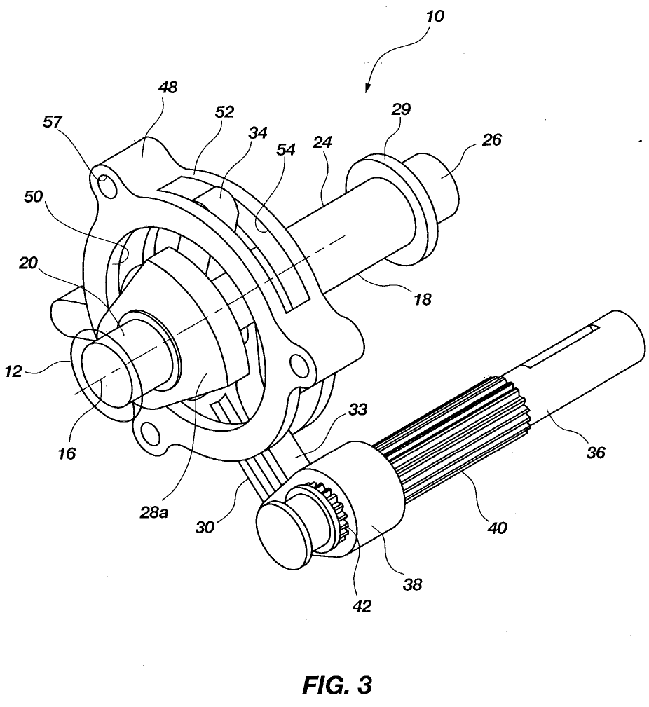

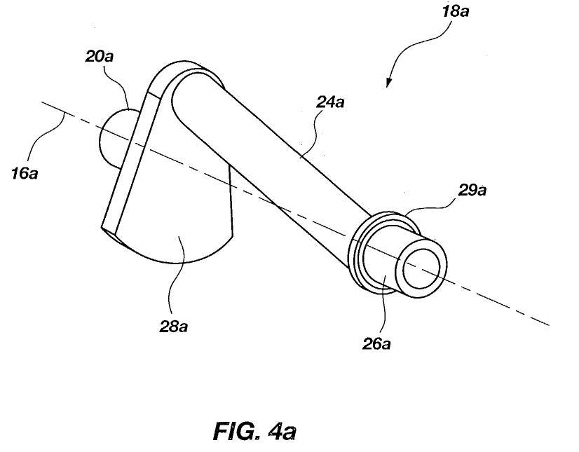

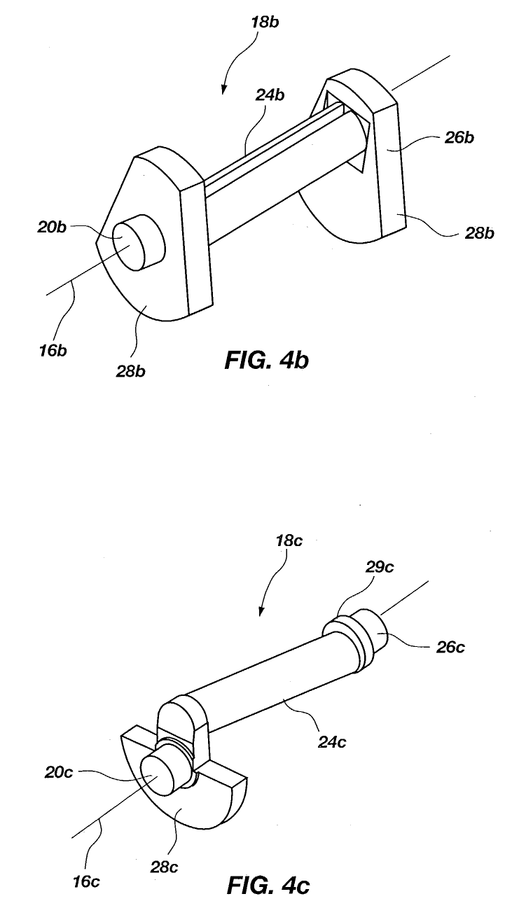

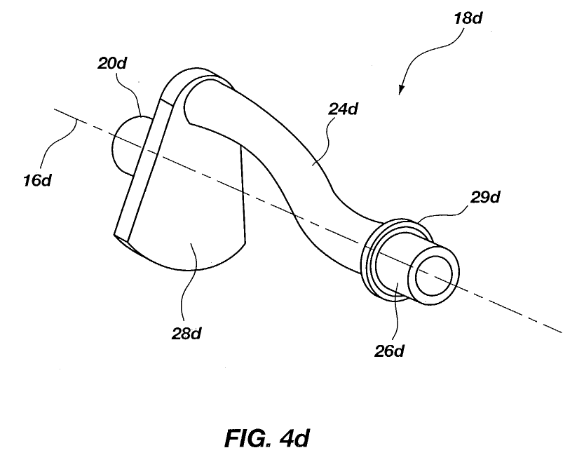

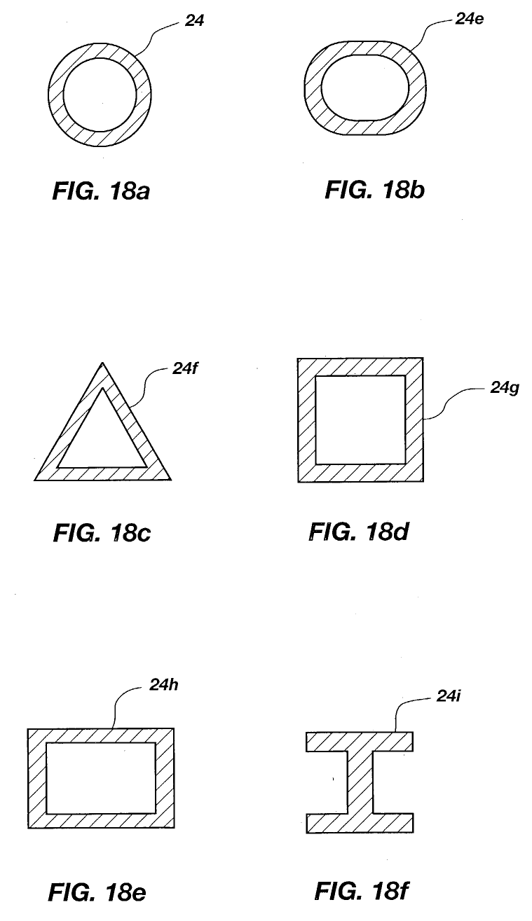

The crankshaft 18 may also include a journal portion 24 extending at an angle α from the first end portion 20 with respect to the axis of rotation 16. The journal portion 24 may extend at any angle a from the axis of rotation 16 within a range of between approximately 0 degrees and approximately 90 degrees. In one embodiment, the angle α may be configured in a range of between approximately 5 degrees and approximately 20 degrees. For example, a crankshaft 18 having a journal portion 24 extending at an angle α of approximately 12 degrees has been demonstrated to exhibit excellent working capabilities for a particular application. However, it will be appreciated that the journal portion 24 may extend at other angles α within the scope of the present invention to meet the required gear ratio needs for a particular use. For example, the gear ratio requirements for a particular use may make various angles α suitable, such as angles α in ranges of between approximately 0-10 degrees, 10-20 degrees, 20-30 degrees, 30-40 degrees, 40-50 degrees, 50-60 degrees, 60-70 degrees, 70-80 degrees, or 80-90 degrees. For example, the journal portion 24 may extend at an angle α of approximately 5, 15, 25, 35, 45, 55, 65, 75, or 85 degrees or any other angle depending upon the particular ratio requirements for a given situation. Moreover, the journal portion 24 may also be curved as shown most clearly in FIG. 4d. The journal portion 24 may have any cross sectional shape, such as round, oblong, triangular, square, rectangular, or I-beam shape, as shown in FIGS. 18a-18f, elements 24, and 24e-24i, for example, or any other suitable shape, either solid or hollow (tubular versions shown in FIGS. 18a-18f may also be solid). Moreover, the journal portion 24 may have a uniform cross sectional shape along the length of the journal portion 24.

The crankshaft 18 may also include a counterweight 28 disposed on the first end portion 20 for balancing the rotational forces of the crankshaft 18 as the crankshaft 18 is rotated. The counter weight 28 may have various shapes known to those skilled in the art, such as a segment of a disk for example. It will be appreciated that the counter weight 28 may be positioned at various locations along the crankshaft 18, including at the second end portion 26. Moreover, multiple counterweights 28 may be positioned on the crankshaft 18, as shown in FIG. 4b for example, within the scope of the present invention. The counterweight 28 may be a solid member having no moving parts, or the counterweight 28 may have adjustable weights 31 (see FIG. 17) attached thereto either on the exterior of the counterweight 28 or within a cavity inside the counterweight 28. The adjustable weights 31 may be moved by any manner known in the art, such as by a threaded engagement or resilient means, to adjust the balance of the counterweight 28.

The second end portion 26 of the crankshaft 18 may be supported on the housing 11 through an end bearing 27. The end bearing 27 may be any variety of bearing known in the art for supporting a shaft while allowing rotation of the shaft and reducing frictional resistance against rotation. A collar 29 may also be formed on the second end portion 26 of the crankshaft 18 for supporting the end bearing 27 and limiting movement of the crankshaft 18 with respect to the housing 11. The bearing portion 24 may extend between the collar 29 and the counterweight 28 and may have a smaller cross-sectional dimension than the collar 29 and the counterweight 28.

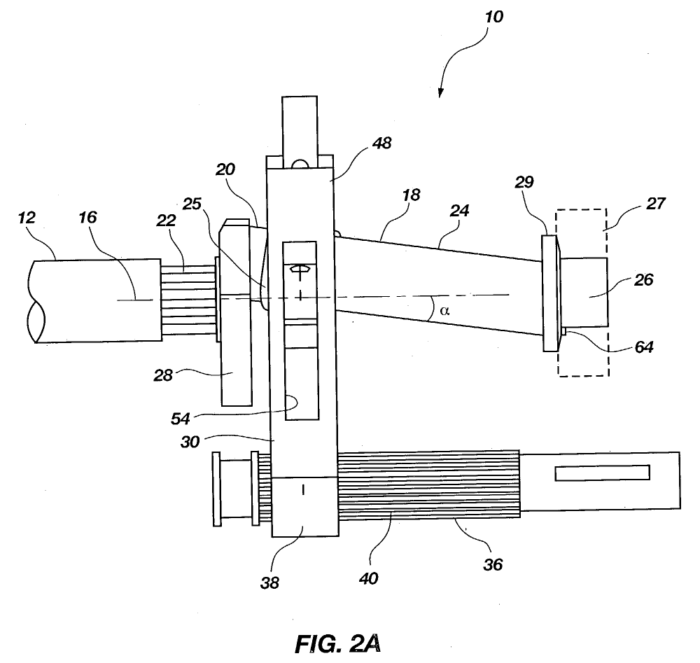

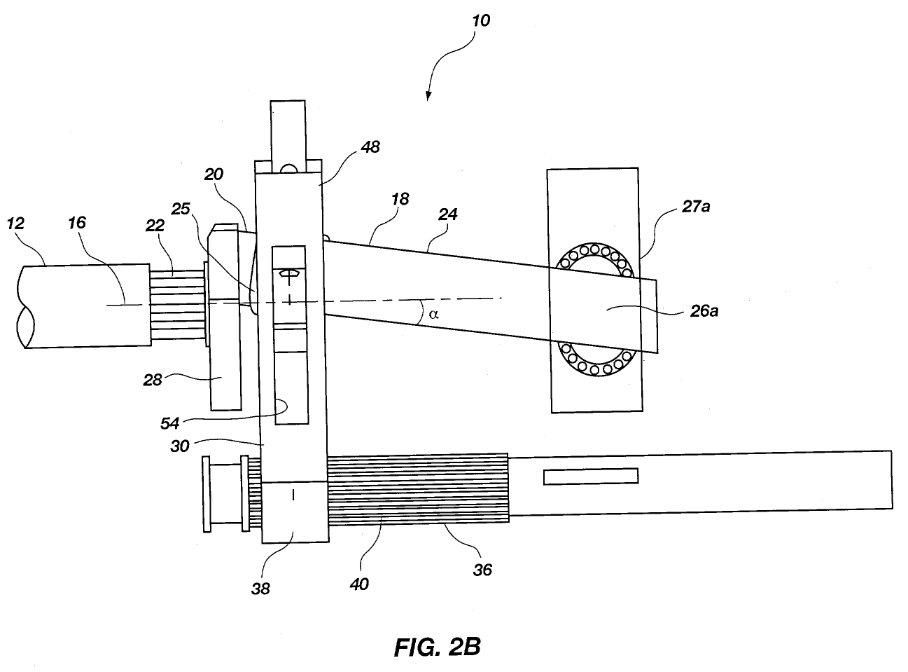

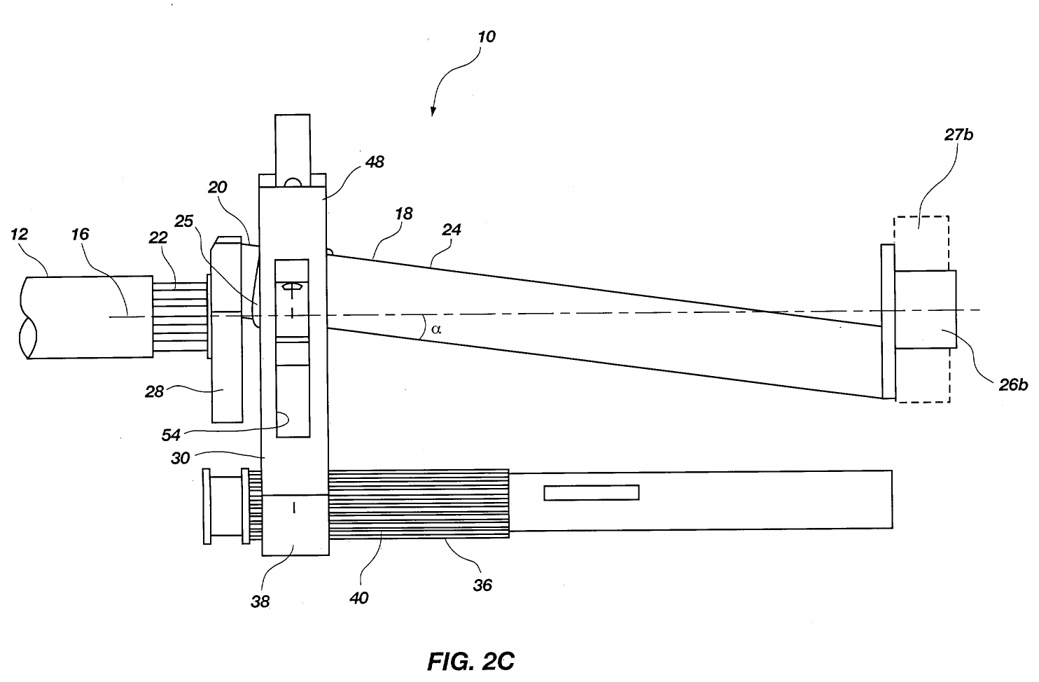

In FIG. 2b is shown an alternative embodiment of the transmission 10, in which the second end portion 26 and end bearing 27 are replaced with spherical or eccentric bearing holding means 27a and non-coaxial end portion 26a. In this embodiment, the non-coaxial end portion 26a is non-coaxial with the axis of rotation 16, thereby necessitating the spherical or eccentric bearing holding means 27a.

In FIG. 2c is shown an additional alternative embodiment of the transmission 10, in which the second end portion 26 and end bearing 27 are replaced with offset coaxial bearing 27b and offset coaxial end portion 26b. In this embodiment, the offset coaxial end portion 26b is coaxial with the axis of rotation 16, but the bearing portion 24 extends below the axis of rotation 16 to enable the connecting arm 30 to be moveable into a sub-neutral position if desired.

As shown in FIGS. 4a-4d, alternative embodiments of the crankshaft 18a-18d may be formed in various different configurations. It will be appreciated that the structures designated by the reference numerals in FIGS. 4a-4d correspond to the structures in FIGS. 1-3 having the same reference numerals. The letters added to the reference numerals in FIGS. 4a-4d are merely intended to indicate alternative embodiments of the features referenced.

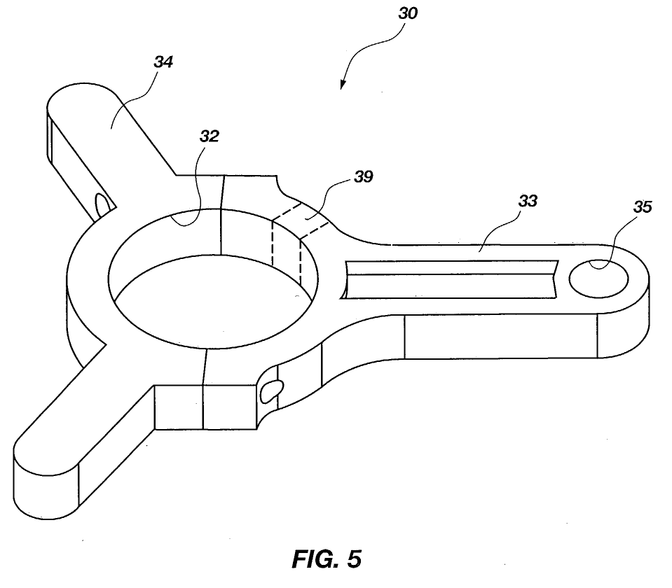

As best shown in FIGS. 1-3, a connecting arm 30 may be attached to the crankshaft 18 using a spherical bearing 25 in a manner such that the connecting arm 30 is allowed to slide along the journal portion 24 and the crankshaft 18 is allowed to rotate with respect to the connecting arm 30. The connecting arm 30 may be attached to the journal portion so as to encompass or circumscribe at least a portion of the journal portion 24 such that the connecting arm 30 may not be separated from the journal portion 24. Accordingly, as the crankshaft 18 is rotated, the connecting arm 30 may be lifted in a movement path, for example, a circular movement path. It will be understood that the connecting arm 30 is configured to be moved in three dimensions as the connecting arm 30 is moved in the movement path about the journal portion 24 and also along the length of the journal portion 24. As shown most clearly in FIG. 5, the connecting arm 30 may include an opening 32 for receiving the journal portion 24 of the crankshaft 18. It will be appreciated that the opening may not be completely circumscribed by the connecting arm 30 as represented by the dashed-line gap 39 in FIG. 5.

One or more prongs 33 may be formed on the connecting arm 30 forming a length of the connecting arm 30 extending away from the opening 32. Attachment means 35, such as a second opening or pin for example, may be disposed near the end of the prong 33 opposite the opening 32 for attaching additional motion transferring components as discussed more fully below. Also, one or more supports 34 may extend from the connecting arm for use in moving the connecting arm 30 along the journal portion 24 as described more fully below.

The connecting arm 30 may be operatively engaged to a second rotational member 36 such that as the angled crankshaft 18 is lifted in the movement path, the second rotational member 36 is forced to rotate back and forth. The second rotational member 36 may be in the form of a splined shaft for example. However, it will be appreciated that the second rotational member 36 may have other configurations such as a rack or gear, for example, within the scope of the present invention.

A foot 38 may be pivotally attached to the connection arm 30 using the attaching means 35 at a location on the prong 33 opposite the opening 32. The pivotal foot 38 may also be attached to the second rotational member 36 through any known mechanism such as a meshing of splines 40 on the second rotational member 36 with teeth 42 on the pivotal foot 38. It will be appreciated that the pivotal foot 38 may be adjustably attached to the second rotational member 36, or the pivotal foot 38 may be fixed to the second rotational member 36 within the scope of the present invention.

The second rotational member 36 may include a gear portion 37 that meshes with an output gear 44 attached to an output shaft 45 such that the movement of the second rotational member 36 may be transferred to the output gear 44. The gear portion 37 may have various shapes, such as a segment of a disc shaped gear, for example. The gear portion 37 may be formed of a larger proportion of a gear for uses in which the journal portion 24 has a larger angle α, for example, whereas when the journal portion 24 has a smaller angle α, the gear portion 37 may be formed of a small proportion of a gear. The output shaft 45 may be attached to a unidirectional clutch means 46 such that the oscillating movement of the second rotational member 36 may be converted into a unidirectional rotation for use in various applications such as powering wheels for example. The unidirectional clutch means 46 may include means for (i) engaging the output shaft 45 in rotational movement when the second rotational member 36 rotates in a first rotational direction and (ii) releasing the output shaft 45 from engagement in rotational movement when the second rotational member 36 rotates in a second, opposing rotational direction. The unidirectional clutch means 46 may be designed in any suitable manner. For example, it will be appreciated that the unidirectional clutch means 46 may be designed using a first unidirectional clutch 47 for engaging the output shaft 45 when the output shaft 45 rotates in one direction, and a second unidirectional clutch 49 for engaging the output shaft 45 when the output shaft 45 rotates in the opposite direction. This allows movement of the second rotational member 36 in both directions to be used for output motion. The output motion from one of the unidirectional clutches may be converted through a reversing means 51 so that the output from both unidirectional clutches rotates in the same direction. The reversing means 51 is shown schematically as a gear, however, it will be appreciated that any mechanism known in the art for reversing rotational output from one direction to another direction may be used within the scope of the present invention.

Other output mechanisms, such as an output flywheel 53, may also be utilized to maintain consistent rotational inertia as the output motion is transmitted for use. Moreover, as shown in FIG. 1a, the output flywheel 53 may include a braking means operatively attached to an output member 55 of the transmission 10. The braking means may include a hydraulic braking system interacting with fins 58 on the flywheel 53. A casing 59 may be fixedly attached to the transmission housing 11 to surround the flywheel 53 so that the flywheel 53 is configured to rotate inside the casing 59. The casing 59 may include a fluid inlet 61 for receiving a braking fluid in a manner known in the art. As the flywheel 53 rotates, the fins 58 contact the braking fluid causing a resistence to rotation of the flywheel 53, thereby causing a braking action to the output member 55. The casing 59 may also include a fluid outlet 63 for releasing the braking fluid in any manner known in the art. As the braking fluid is released the flywheel 53 can again rotate unimpeded so that the braking action on the output member 55 is released. It will be understood that the output member 55 may be attached to the flywheel 53 using a key 67 or splines in a manner known in the art. Moreover, other braking means known in the art may be attached to the output member 55 within the scope of the present invention.

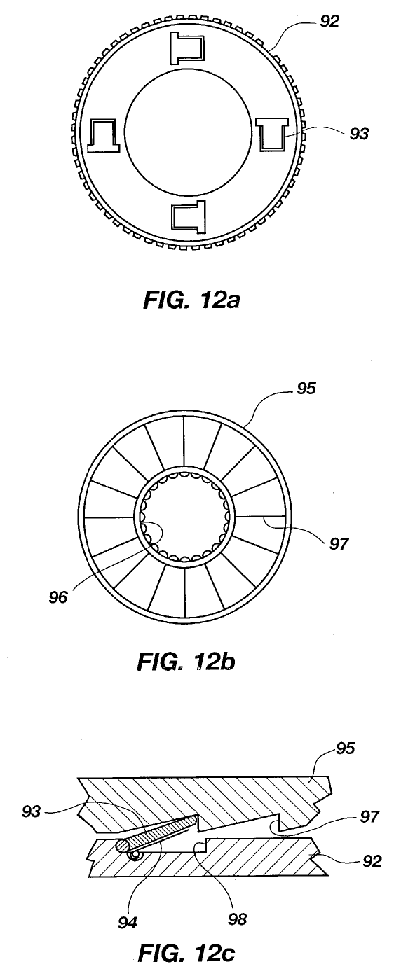

A variety of different unidirectional clutch means may be used in the transmission 10. For example, as shown in FIGS. 12a-12c, the unidirectional clutch means may include a gear portion 92 having a plurality of struts 93 on an inner surface that are biased outwardly by springs 94. A notch plate 95 may fit within the gear portion 92 and may include a splined opening 96 for receiving the output shaft 45. A plurality of notches 97 may be formed in the notch plate 95 that engage the struts 93 to lock the gear portion 92 to the notch plate 95 when the notch plate 95 is moved in one direction, whereas the notch plate 95 may be allowed to move with respect to the gear portion 92 when the notch plate is moved in the opposite direction, as the struts 93 are pushed into recesses 98 in the gear portion 92. Accordingly, the output shaft 45 may be allowed to transfer motion to the gear portion 92 through engagement of the struts 93 with the notches 97 when the output shaft 45 is rotated in one direction, whereas when the output shaft 45 is rotated in the opposite direction the struts 93 slide along the notch plate 95 without engagement so that the notch plate 95 rotates freely within the gear portion 92.

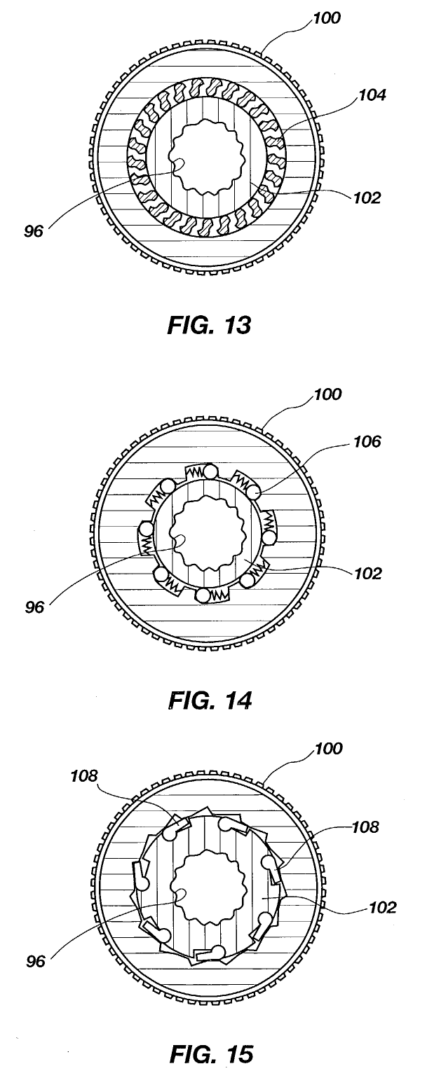

An additional embodiment of the unidirectional clutch means is shown in FIG. 13 wherein an outer race 100 may be locked to an inner race 102 by means of a plurality of sprags 104. The sprags 104 are shaped to allow movement of the outer race 100 in one direction with respect to the inner race, whereas movement in the opposite direction causes the sprags 104 to lock the outer race 100 to the inner race 102 and thereby transfer motion from the output shaft 45 to the outer race 100.

Similarly, as shown in FIG. 14, the unidirectional clutch means may include biased rollers 106 that lock the outer race 100 to the inner race 102 when the inner race 102 is moved in one direction. Other locking mechanisms such as pawls or ratchets 108 may also be used to lock the outer race 100 to the inner race 102 during movement in one direction, as shown most clearly in the unidirectional ratcheting clutch of FIG. 15. It will be appreciated that all such mechanisms are included within the scope of a unidirectional clutch means.

It will be understood that the second rotational member 36 may be attached to the unidirectional clutch means 46 directly, without the use of the gear portion 37 and the output gear 44.

The transmission 10 may also include a guide 48, as shown in FIGS. 1-3, for positioning the connecting arm 30 along the journal portion 24. The guide 48 may define a chamber 50 for receiving the connecting arm 30. The chamber 50 may be cylindrical in shape and may include a sidewall 52 having one or more slots 54 for portions of the connecting arm 30, including the prong 33 and supports 34, to pass through the guide 48.

The guide 48 may be positioned coaxially with the axis of rotation 16 and configured to be moved along the length of the crankshaft 18. Any means known in the art for moving the guide 48 may be used. For example, one or more threaded rods 56 may be attached to the guide 48 at keepers 57. In one embodiment of the guide, three threaded rods 56 are equidistantly spaced around a perimeter of the guide 48. However, it will be understood that any number of threaded rods 56 may be used within the scope of the present invention. The threaded rods 56 may be rotated to cause the guide 48 to move towards and away from the first rotational member 12. Similarly, a suitable hydraulic ram system, or other mechanism known in the art may be used to move the guide 48. It will be understood that the guide 48 and the threaded rod 56 is one example of a means for adjusting a position of the connecting arm 30 along a length of the journal portion 24. Alternatively, it will also be understood that the guide 48 may remain stationary and the journal portion 24 may be moved with respect to the guide 48 within the scope of the present invention.

It will be appreciated that as the guide 48 is moved closer to the first rotation member 12 the connecting arm 30 is moved along the journal portion 24 of the crankshaft 18 such that movement path of the connecting arm 30 becomes larger. This in turn modifies the ratio of movement between the first rotational member 12 and the second rotational member 36. Similarly, the ratio of movement between the first rotational member 12 and the second rotational member 36 may be decreased by moving the guide 48 (and the connecting arm 30) further away from the first rotational member 12 such that the movement path of the connecting arm 30 becomes smaller as the radial distance of the journal portion 24 from the axis of rotation 16 becomes smaller. Accordingly, the transmission 10 may provide variable ratios of movement as connecting arm 30 is moved along the journal portion 24 of the crankshaft 18. It will be appreciated that the connecting arm 30 may be moved in specified steps, or in a continuous manner along the journal portion 24 of the angled crankshaft 18. Moreover, the second end portion 26 of the crankshaft 18 may be configured such that the connecting arm 30 may be positioned on the axis of rotation 16. This position of the connecting arm 30 allows the journal portion 24 of the crankshaft 18 to be rotated within the connecting arm 30 without lifting the connecting arm 30. The connecting arm 30 may thereby be placed in a neutral condition. As shown most clearly in FIG. 2a, the angled journal portion 24 at the second end portion 26 may be configured to extend below the axis of rotation 16 to allow the connecting arm 30 to be positioned on the axis of rotation 16 despite the sloping configuration of the journal portion 24. In other words, if the journal portion 24 were configured to be aligned with the axis of rotation at the second end portion 26 of the crankshaft 18, the thickness of the connecting arm 30 would cause the center of rotation in the middle of the connecting arm 30 to be positioned above the axis of rotation 16 due to the sloping of the journal portion 24. Accordingly, the journal portion 24 may have an offset 64 from the axis of rotation 16 to allow the center of rotation of the connecting arm 30 to be positioned on the axis of rotation 16 so that the connecting arm 30 is not moved by rotation of the journal portion 24.

Operation of the means for adjusting a position of the connecting arm 30 along a length of the journal portion 24 may be performed by an automatic or computerized system. The automatic system may utilize procedures known in the art to measure characteristics, such as velocity, of various components of the transmission 10 or of a vehicle incorporating the transmission 10 for example. Based on the measured characteristics, the automatic system may be designed to adjust the position of the connecting arm 30 along the length of the journal portion 24. Accordingly, optimal movement ratios may be selected. Also, the transmission 10 may be manually operated such that the operator of the transmission 10 may manually select and adjust the position of the connecting arm 30 along the journal portion 24.

In operation, the first rotational member 12 may be rotated by a force from the means for rotating, such as an engine. Rotation of the first rotational member 12 causes the crankshaft 18 to rotate about the axis of rotation 16. When the connecting arm 30 is positioned on the journal portion 24 of the crankshaft 18 away from the axis of rotation 16, the connecting arm 30 is lifted in a movement path. The movement of the connecting arm 30 is then transferred through the pivotal foot 38 to the second rotational member 36. The second rotational member 36 is thereby rotated back and forth as the connecting arm 30 is moved through the movement path. The back and forth movement of the second rotational member 36 may then be transferred to the output gear 44, the output shaft 45, and through the unidirectional clutch means 46. To increase the ratio of movement between the first rotational member 12 and the second rotational member 36, the connecting arm 30 may be moved along the journal portion 24 of the crankshaft 18 by rotating the threaded rods 56 to move the guide 48. The supports 34 on the connecting arm 30 may be carried by the guide 48 to reposition the connecting arm 30 with the guide 48. As the guide 48 moves the connecting arm 30 along the journal portion 24 toward the first end portion 20, the radial distance from the axis of rotation 16 to the journal portion 24 is increased, thereby increasing the ratio of movement between the first rotational member 12 and the second rotational member 36. The connecting arm 30 may be moved closer to the second end 26 of the crankshaft 18 to reduce the ratio of movement between the first rotational member 12 and the second rotational member 36. The connecting arm 30 may be positioned in alignment with the axis of rotation 16 so that the connecting arm 30 is in a neutral position and does not transfer movement to the second rotational member 36 when the connecting-arm 30 is positioned at the second end portion 26 of the crankshaft 18.

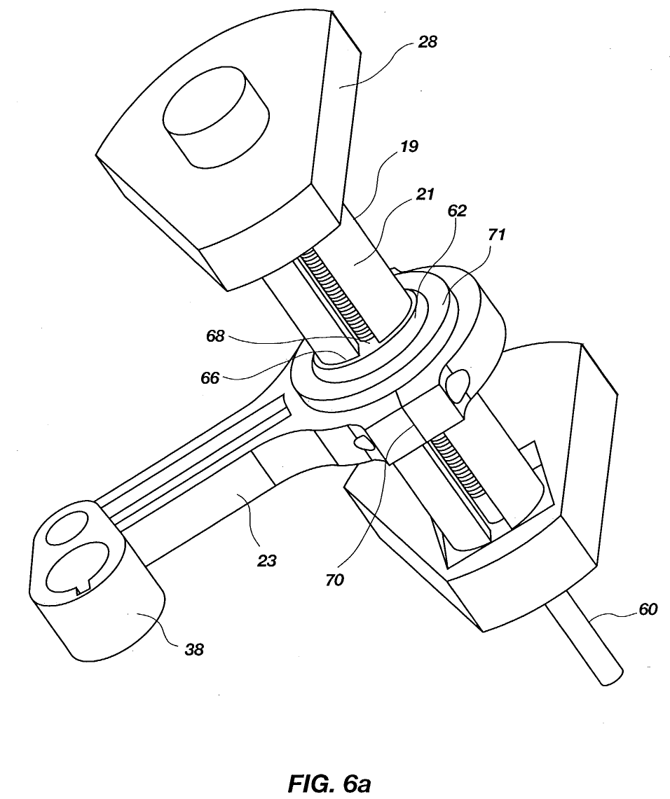

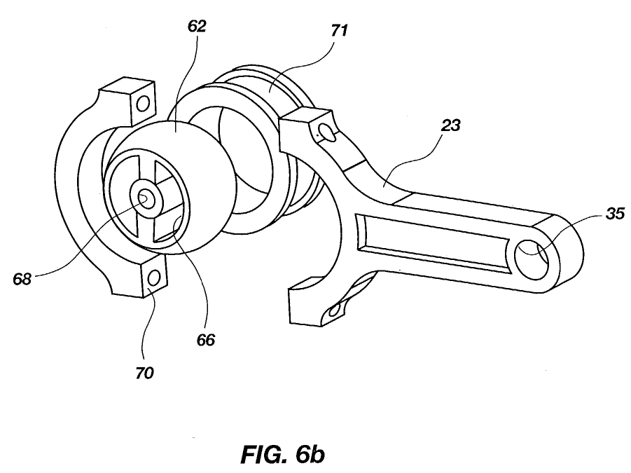

Referring now to FIG. 6a, a further preferred embodiment of the crankshaft is shown, indicated by reference numeral 19. The crankshaft 19 may have a split journal 21 for receiving connecting arm adjustment means, such as threaded journal rod 60 therein. This embodiment of the invention provides a different example of a means for adjusting a position of the connecting arm 23 along a length of the journal portion 21.

A bearing 62, as best shown in FIG. 6b, may be positioned between the connecting arm 23 and the split journal 21 to allow rotation of the connecting arm 23 with respect to the split journal 21 and to adjust the position of the connecting arm 23 along the length of the split journal 21. Accordingly, the bearing 62 may be configured to perform some of the functions performed by the guide 48. The bearing 62 may have a somewhat spherical external configuration for example, and may have a journal opening 66 for receiving the split journal 21 thereinto. The journal opening 66 may be divided into two separate sections to receive two separate portions of the split journal 21. However, it will be appreciated that the journal opening 66 may have a variety of configurations to receive the split journal 21. The bearing 62 may also include a bore 68 that may be threaded for receiving the journal rod 60, that may also be threaded such that as the threaded journal rod 60 is rotated with respect to the split journal 21, the position of the bearing 62 may be adjusted along the length of the split journal 21. Accordingly, the position of the connecting arm 23 may also be adjusted along the length of the split journal 21 to thereby modify the ratio of movement of the second rotational member 36 with respect to the first rotational member 12. It will be appreciated that other movement mechanisms such as a hydraulic ram, for example, may be positioned within the split journal 21 and the bearing 62.

The connecting arm 23 used in the embodiment of FIG. 6a-6b may be formed without the supports 34, since movement of the connecting arm is effected through the bearing 62. Moreover, the connecting arm 23 may be formed in a plurality of pieces connected together at a joint 70 using any variety of fastening means known in the art. This configuration may facilitate installation of the connecting arm 23 about the bearing 62 and the split journal 21. A ring 71 may be positioned between the bearing 62 and the connecting arm 23 to help secure the bearing 62 to the connecting arm 23, and to add additional bearing means. For example, ring 71 provides an enhanced ability of the connecting arm 23 to rotate about an axis of ring 71.

Referring now to FIGS. 7a-7d, an embodiment of the invention is shown utilizing a rack 72 and pinion 74. It will be appreciated that either the crankshaft 18 having a split journal 19 or the journal 24 and guide 48 may be used to drive a rack 72 and pinion 74. The connecting arm 23 may have a connection 76 with the rack 72. The connection 76 may be of any variety known in the art such as a pivotal connection that allows rotational movement between the connecting arm 23 and the rack 72, or a ball connection that allows multi-directional movement between the connecting arm 23 and the rack 72. Accordingly, the connecting arm 23 may force the rack 72 to reciprocate as the crankshaft 18 is rotated. In one embodiment, the rack 72 may be held in a groove 75 in the housing 11 such that the rack may be forced to translate in the groove 75 by movement of the connecting arm 23. In other embodiments, the rack 72 may be allowed to undergo rotational movement. The rack 72 may have teeth 78 that mesh with teeth 80 on the pinion 74 such that the movement of the rack 72 causes the pinion 74 to rotate. It will be appreciated that the pinion 74 may be attached to the output shaft 45 and a unidirectional clutch means 46 to provide an output as discussed above.

It is to be understood that the concepts of the present invention may be used with other mechanisms in addition to the rack 72 and pinion 74, such as splined shaft or a chain 81 and sprocket 83, for example as shown in FIG. 8. The chain 81 may be a push chain enclosed in a channel 85 to transfer reciprocating movement to the sprocket 83. The movement of the sprocket 83 may then be transferred to an output shaft 45 in a manner similar to the rack 72 and pinion 74 embodiment discussed above.

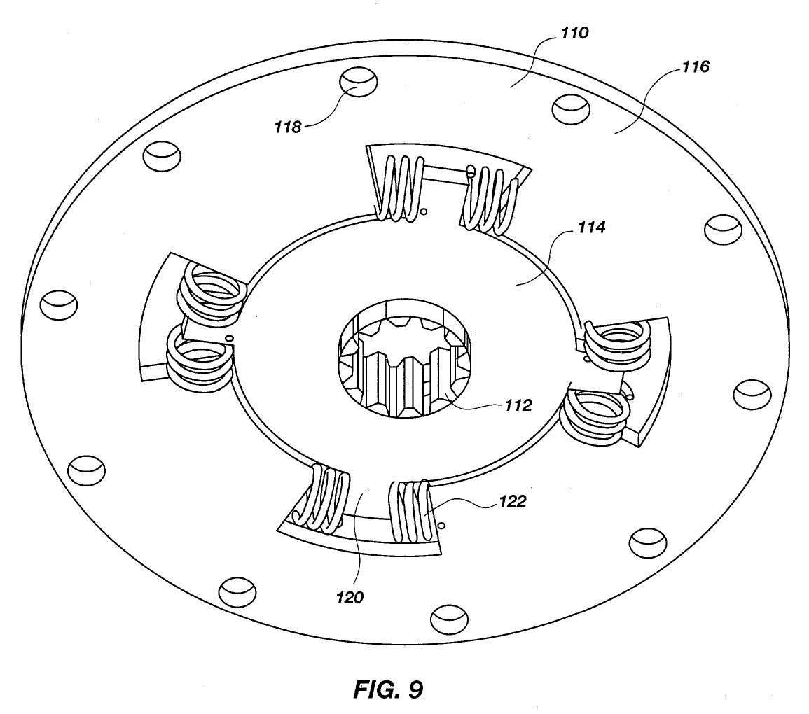

Referring now to FIG. 9, a perspective view of a flex coupling 110 is shown for use in providing a more uniform force output by the transmission 10. The flex coupling 110 may be attached to the first end 20 of the crankshaft 18 through the central opening 112 positioned in an inner portion 114 of the flex coupling 110. An outer portion 116 of the flex coupling 110 may have fastener holes 118 for receiving fasteners to attach the flex coupling 110 to a first rotational member 12 such as a fly wheel on an engine (not shown). The inner portion 114 may include tabs 120 and biasing means 122 received in gaps 124 formed in the outer portion 116. Accordingly, the inner portion 114 is allowed to move with respect to the outer portion 116 against the biasing means 122 to absorb forces exerted on the flex coupling. This arrangement helps provide a more smooth operation of the transmission 10. As the crankshaft 18 is rotated, there are times when more force is exerted by the crankshaft 18 to drive the second rotational member 36. For example, a graph of the force exerted by the crankshaft 18 may be depicted as a sinusoidal curve as the connecting arm 30 pushes the second rotational member 36 to rotate in one direction, then stops and pulls the second rotational member 36 to rotate in the opposite direction. This sinusoidal variation in forces exerted by the crankshaft 18 may be dampened to a more uniform supply of force by attaching the crankshaft 18 to the first rotational member 12 through the flex coupling 110. The peak forces exerted by the crankshaft 18 may be absorbed into the biasing means 122 and released as the biasing means 122 restores the inner portion 114 of the flex coupling 110 to its relaxed position. Thus, the output forces produced by the transmission 10 become more uniform.

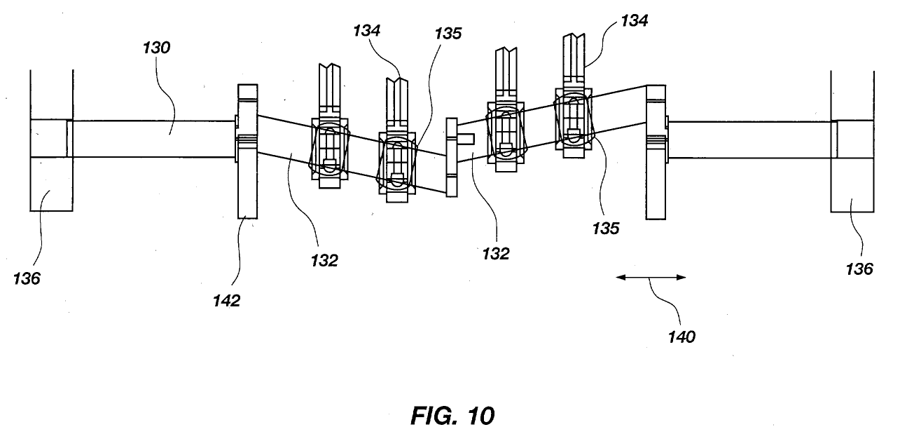

Referring now to FIG. 10, it will be appreciated that the principles of the present invention may be used in a crankshaft 130 having multiple journal portions 132, and multiple connecting arms 134 supported on the journal portions 132 by spherical connecting arm bearings 135. Moreover, the crankshaft 130 may be moved with respect to the connecting arms 134 to adjust the location of the connecting arms 134 on the journal portions 132. As shown in the embodiment of FIG. 10, the crankshaft 130 may be supported on end supports 136. As the crankshaft is moved in the directions indicated by arrow 140, the position of the connecting arms 134 may be adjusted on the journal portion 132. Counterweights 142 may be positioned on the crankshaft 130 as desired to balance the crankshaft 130.

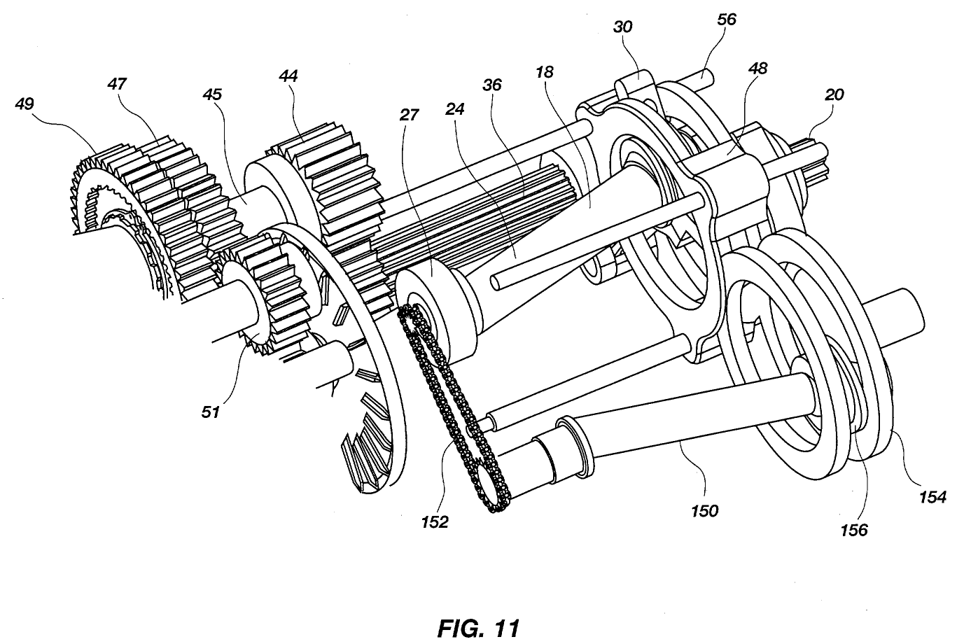

Additional balancing of the transmission 10 may be accomplished as described with reference to FIG. 11. Those skilled in the art will understand that the concepts of the present invention may be used with multiple shafts. One or more counterbalance shafts 150 may be added to the transmission 10. The counterbalance shaft 150 may be rotated in the same direction as the crankshaft 18, except that the counterbalance shaft 150 may be positioned out of sequence with the crankshaft 18. In one embodiment, the counterbalance shaft 150 may be positioned approximately 180 degrees out of sequence with the crankshaft 18. However, it will be appreciated that the counterbalance shaft 150 may be arranged in any angular position with respect to the crankshaft 18 as desired.

The embodiment of FIG. 11 depicts the counterbalance shaft 150 being driven by a chain 152 attached to the crankshaft 18. This allows movement of the counterbalance shaft 150 to be synchronized with the crankshaft 18. It will be appreciated that the counterbalance shaft 150 may be driven by other mechanisms and may be driven independently from the crankshaft 18 within the scope of the present invention.

A second guide 154 may be attached to the guide 48 to move an adjustable weight 156 along the counterbalance shaft 150. Accordingly, the movement of the adjustable weight 156 may be configured to offset the forces created by rotation of the connecting arm 30 and the crankshaft 18, so that the transmission 10 may operate more smoothly. It will be appreciated that the counterbalance shaft 150 may also be configured to operate independently from the crankshaft 18. For example, the second guide 154 may not be connected to the guide 48 so that the adjustable weight 156 may be moved independently of the guide 48. This will allow the adjustable weight 156 to be positioned in accordance with a measured or calculated condition to achieve the desired affect. For example, computer means may be utilized to provide the angular offset of the counterbalance shaft 150 as well as the position of the second guide 154 and adjustable weight 156 along the counterbalance shaft 150 to achieve the optimal effects.

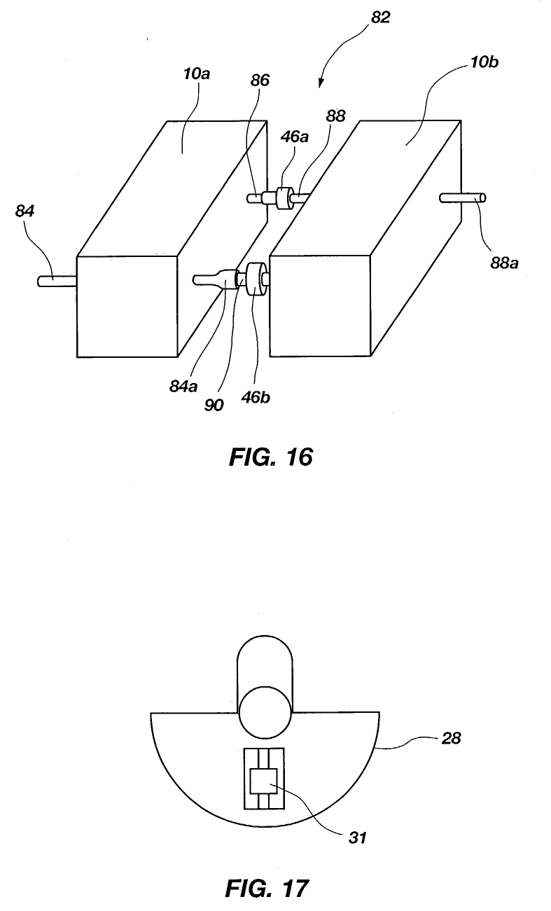

Referring now to FIG. 16, an additional feature of the present invention is shown wherein a plurality of transmissions 10a and 10b may be configured to provide a compression braking non-freewheeling device, indicated generally at 82. The compression device 82 may include a first transmission 10a having an input shaft 84 and an output shaft 86 capable of transmitting torsional force through transmission 10a generally to accomplish different gear ratios between input shaft 84 and output shaft 86 as discussed above. Output shaft 86 may then be connected to unidirectional clutch means 46a which may be connected to input shaft 88 of transmission 10b in such a manner to allow torsional force to be transmitted from output shaft 86 to input shaft 88 of transmission 10b in a single direction. Transmission 10b may have an input shaft 88 and an output shaft 90 capable of transmitting torsional force through transmission 10b generally to accomplish different gear ratios as discussed above. Output shaft 90 may be connected to a unidirectional clutch 46b which may be connected to input shaft 84a in such a manner to allow torsional force to be transmitted from output shaft 90 to input shaft 84a in a single direction, which in FIG. 16 is the opposite end of input shaft 84, but shaft 84a can simply be connected to input shaft 84 by other means also. Output/input shaft 88a may also be the other end of shaft 88, or it can be connected in some manner to input shaft 88. Output/input shaft 88a may be generally connected to the driven member of the vehicle this device is in, while input shaft 84 may be generally connected to the driving member, or engine of the vehicle.

In operation of the compression braking device 82, torsional force can be applied to the input shaft 84, or to output/input shaft 88a. When input torsional force rotates the first input shaft 84, rotational output movement of output shaft 86 through transmission 10a occurs, which in turn causes torsional force to travel through clutch 46a to input shaft 88 of transmission 10b, forcing input shaft 88 to rotate. Input shaft 88 then transmits rotational force through transmission 10b to both output shaft 88a, and output shaft 90. Shaft 88a is generally connected in some manner to a driven device, while output shaft 90 is connected either directly or indirectly to input shaft 84a, generally through unidirectional clutch 46b. Output shaft 90 transfers power through these means back into transmission 10a through input shaft 84a, while rotational force is also being transferred simultaneously through output shaft 88a, which is generally the overall output shaft of compression braking transmission device 82. For example if this transmission were to be used in an automobile, the engine would generally turn input shaft 84, and output shaft 88a would generally turn the wheels (either directly or indirectly). While power is being supplied to input shaft 84, transmissions 10a and 10b should operate in a certain balance with each other, or transmission 10b can even be allowed to freewheel, by means of the unidirectional clutches.

In the reverse operation, the compression braking device 82 operates by receiving rotational input force through output/input shaft 88a, which causes rotational output of output shaft 90, which transfers rotational force through clutch 46b causing input shaft 84a to rotate, forcing the rotation of input shaft 84. The reverse operation of this device causes compression braking to occur, if an engine is attached to input shaft 84 (either directly or indirectly), and if output/input shaft 88a is attached to a driven device, such as an automobile. If the automobile engine was attached in some manner to shaft 84 to allow transmission of torsional force, and the wheels of the automobile were attached in some manner to shaft 88a to also allow torsional force transmission. During acceleration of the automobile the rotational force would simply travel through transmission 10a as described earlier into transmission 10b also described earlier, and then through transmission 10b to shaft 88a, which would transfer rotational force to the wheels of the automobile, directly or indirectly. During deceleration, the wheels would then cause shaft 88a to be rotated, causing rotational force to go through transmission 10b to output shaft 90, transferring rotational force through clutch 46b, and through input shaft 84a, to input shaft 84, which would then transmit this torsional force back into the engine, forcing the engine to turn at some given revolutions per minute (r.p.m.), which is faster than the engine would otherwise be turning the transmission at the given time. Because the engine is being forced to turn at this higher r.p.m., the engine creates drag, (a term known to those skilled in the art) which causes the vehicle to slow down. In other words the compression, friction, and/or other forces in the engine are causing the automobile to decelerate, or creating compression braking.

The two unidirectional clutches 46a and 46b are used to allow freewheeling of the transmissions when needed. During acceleration clutch 46b would allow shaft 84a to freewheel, while during deceleration clutch 46a would allow shaft 88 to freewheel if necessary.

It should also be understood that although the transmissions 10a and 10b operate together to create a single compression braking transmission device, three or more transmissions could function together to perform this same task.

It is to be understood that each of the components of the transmission 10 may be constructed of any of a variety of materials known in the art having suitable strength and durability characteristics. It will also be understood that the transmission 10 may be operated in the direction opposite to that described above. That is, input force may be supplied to the second rotational member 36 or rack 72 by a reciprocating piston, for example, to thereby cause rotational movement to the crankshaft 18 and first rotational member 12.

It will be appreciated that the structure and apparatus disclosed herein is merely one example of a means for adjusting a position of the connecting arm along a length of the journal portion, and it should be appreciated that any structure, apparatus or system for adjusting a position of the connecting arm along a length of the journal portion which performs functions the same as, or equivalent to, those disclosed herein are intended to fall within the scope of a means for adjusting a position of the connecting arm along a length of the journal portion, including those structures, apparatus or systems for adjusting a position of the connecting arm along a length of the journal portion which are presently known, or which may become available in the future. Anything which functions the same as, or equivalently to, a means for adjusting a position of the connecting arm along a length of the journal portion falls within the scope of this element.

It will be appreciated that the structure and apparatus disclosed herein is merely one example of a unidirectional clutch means, and it should be appreciated that any structure, apparatus or system which performs functions the same as, or equivalent to, those disclosed herein are intended to fall within the scope of a unidirectional clutch means, including those structures, apparatus or systems which are presently known, or which may become available in the future. Anything which functions the same as, or equivalently to, unidirectional clutch means falls within the scope of this element.

In accordance with the features and combinations described above, a useful method of transmitting movement from a first rotational member to a second rotational member includes the steps of:

(a) attaching a crankshaft to the first rotational member;

(b) attaching a connecting arm to the crankshaft and the second rotational member; and

(c) moving the connecting arm in three-dimensions along the crankshaft to modify a ratio of movement between the first rotational member and the second rotational member.

Those having ordinary skill in the relevant art will appreciate the advantages provided by the features of the present invention. For example, it is a feature of the present invention to provide a transmission device that is simple in design and manufacture. Another feature of the present invention is to provide such a transmission device that is capable of converting motion at variable ratios, with fewer moving parts in the ratio-variation structure. The angled crankshaft aspect of the invention allows the connecting arm radius of rotation to change without physically altering the crank member, thereby providing a higher-strength structure. It is a further feature of the present invention, in accordance with one aspect thereof, to provide a transmission device that is capable of varying a ratio of movement between members during movement of the members.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A transmission device comprising:
a crankshaft for attaching to a first rotational member, said crankshaft comprising a first end portion and a second end portion opposite said first end portion, said crankshaft further comprising a journal portion extending between said first end portion and said second end portion;
a connecting arm joined to said journal portion so as to encompass at least a portion of said journal portion, said connecting arm configured to be movable along a length of said journal portion;
wherein an axis of rotation of said crankshaft extends in a direction from said first end portion to said second end portion and said journal portion extends at an angle with respect to said axis of rotation.

2. The transmission device of claim 1, further comprising a second rotational member operatively connected to said connecting arm;
wherein movement of said connecting arm along said journal portion is configured to modify a ratio of movement between said first rotational member and said second rotational member.

3. The transmission device of claim 2, wherein said second rotational member comprises a splined shaft.

4. The transmission device of claim 2, further comprising a gear portion disposed on said second rotational member.

5. The transmission device of claim 4, further comprising an output gear in meshing engagement with said gear portion.

6. The transmission device of claim 5, further comprising an output shaft disposed on said output gear.

7. The transmission device of claim 6, further comprising unidirectional clutch means disposed on said output shaft.

8. The transmission device of claim 7, wherein said unidirectional clutch means comprises a first unidirectional clutch and a second unidirectional clutch.

9. The transmission device of claim 8, wherein one of said first unidirectional clutch and said second unidirectional clutch is attached to reversing means for reversing the direction of rotational output.

10. The transmission device of claim 9, wherein said means for reversing the direction of rotational output comprises a gear.

11. The transmission device of claim 2, further comprising a foot pivotally attached to said connecting arm and fixedly attached to said second rotational member for transmitting movement of said connecting arm to said second rotational member.

12. The transmission device of claim 11, wherein said foot comprises teeth configured for engaging with splines on the second rotational member.

13. The transmission device of claim 1, further comprises a unidirectional clutch means.

14. The transmission device of claim 13, wherein the unidirectional clutch means comprises means for (i) engaging an output shaft in rotational movement when the second rotational member rotates in a first rotational direction and (ii) releasing the output shaft from engagement in rotational movement when the second rotational member rotates in a second, opposing rotational direction.

15. The transmission device of claim 14, wherein said unidirectional clutch means comprises a first unidirectional clutch and a second unidirectional clutch.

16. The transmission device of claim 13, wherein said unidirectional clutch means comprises a first unidirectional clutch.

17. The transmission device of claim 15, wherein said first unidirectional clutch comprises means for (i) engaging an output shaft in rotational movement when the second rotational member rotates in a first rotational direction and (ii) releasing the output shaft from engagement in rotational movement when the second rotational member rotates in a second, opposing rotational direction.

18. The transmission device of claim 17, wherein said second unidirectional clutch comprises means for (i) engaging the output shaft in rotational movement when the second rotational member rotates in the second rotational direction and (ii) releasing the output shaft from engagement in rotational movement when the second rotational member rotates in the first rotational direction.

19. The transmission device of claim 13, wherein said unidirectional clutch means comprises a gear portion.

20. The transmission device of claim 13, wherein the unidirectional clutch means comprises a notch plate.

21. The transmission device of claim 20, wherein said notch plate comprises an opening for receiving an output shaft.

22. The transmission device of claim 21, wherein said opening comprises splines.

23. The transmission device of claim 20, wherein said notch plate comprises a plurality of notches.

24. The transmission device of claim 13, wherein said unidirectional clutch means comprises one or more struts.

25. The transmission device of claim 24, wherein said one or more struts are biased by springs.

26. The transmission device of claim 13, wherein said unidirectional clutch means comprises an outer race and an inner race.

27. The transmission device of claim 26, wherein said inner race comprises an opening for receiving an output shaft.

28. The transmission device of claim 27, wherein said opening comprises splines.

29. The transmission device of claim 13, wherein said unidirectional clutch means comprises one or more sprags.

30. The transmission device of claim 13, wherein said unidirectional clutch means comprises one or more rollers.

31. The transmission device of claim 30, wherein said one or more rollers are biased by springs.

32. The transmission device of claim 13, wherein said unidirectional clutch means comprises one or more ratchets.

33. The transmission device of claim 1, further comprising means for adjusting a position of said connecting arm along said length of said journal portion.

34. The transmission device of claim 33, wherein said means for adjusting a position of said connecting arm along said length of said journal portion comprises a guide for receiving said connecting arm.

35. The transmission device of claim 34, wherein said guide comprises a sidewall defining a chamber for receiving said journal portion therethrough.

36. The transmission device of claim 35, wherein said chamber is positioned in axial alignment with said axis of rotation.

37. The transmission device of claim 35, wherein said sidewall comprises a plurality of slots for receiving supports on said connecting arm.

38. The transmission device of claim 37, wherein said plurality of slots comprises three slots.

39. The transmission device of claim 34, wherein said means for adjusting a position of said connecting arm along said length of said journal portion further comprises at least one threaded rod for moving said guide.

40. The transmission device of claim 39, wherein said guide further comprises at least one keeper for receiving said at least one threaded rod.

41. The transmission device of claim 40, wherein said means for adjusting a position of said connecting arm along said length of said journal portion comprises three threaded rods equidistantly spaced apart.

42. The transmission device of claim 33, wherein said means for adjusting a position of said connecting arm along said length of said journal portion comprises a threaded journal rod received in said journal portion.

43. The transmission device of claim 42, wherein said means for adjusting a position of said connecting arm along said length of said journal portion further comprises a bearing having a threaded bore for receiving said threaded journal rod.

44. The transmission device of claim 1, further comprising a bearing disposed between said connecting arm and said journal portion of said crankshaft to allow said journal portion to rotate with respect to said connecting arm.

45. The transmission device of claim 44, wherein said bearing comprises a substantially spherical configuration.

46. The transmission device of claim 44, wherein said bearing comprises a journal opening for receiving said journal portion.

47. The transmission device of claim 46, wherein the journal opening is split into two sections.

48. The transmission device of claim 44, wherein said bearing comprises a bore for receiving a rod.

49. The transmission device of claim 48, wherein said bore is threaded.

50. The transmission device of claim 44, further comprising a ring disposed between the bearing and the connecting arm.

51. The transmission device of claim 1, further comprising means for attaching the crankshaft to the first rotational member disposed on a first end portion of the crankshaft.

52. The transmission device of claim 51, wherein the means for attaching the crankshaft to the first rotational member comprises splines on the crankshaft.

53. The transmission device of claim 1, wherein said crankshaft further comprises a collar disposed on said second end portion.

54. The transmission device of claim 1, wherein said journal portion comprises a curved configuration along a length of said journal portion.

55. The transmission device of claim 1, wherein said first end portion and said second end portion are aligned with said axis of rotation.

56. The transmission device of claim 1, wherein said journal portion comprises a round cross-sectional shape.

57. The transmission device of claim 1, wherein said journal portion comprises a uniform cross-sectional shape along a length of said journal portion.

58. The transmission device of claim 1, wherein said crankshaft comprises a counterweight disposed on said first end portion and a collar disposed on said second end portion, and wherein said journal portion has a smaller cross-sectional dimension than said counterweight and said collar.

59. The transmission device of claim 1, wherein said crankshaft is configured such that at least a portion of a length of said journal portion has a cross-section that is entirely spaced apart from said axis of rotation.

60. The transmission device of claim 1, wherein said journal portion is configured such that said connecting arm is positionable on said journal portion at a neutral position on said axis of rotation such that said connecting arm does not transfer movement to said second rotational member when said connecting arm is in said neutral position.

61. The transmission device of claim 1, wherein said crankshaft further comprises a counterweight for balancing said crankshaft when said crankshaft is rotated about said axis of rotation.

62. The transmission device of claim 61, wherein said counterweight is positioned on said first end portion of said crankshaft.

63. The transmission device of claim 62, wherein said counterweight is positioned on said second end portion of said crankshaft.

64. The transmission device of claim 1, wherein said crankshaft further comprises a counterweight positioned on each of said first end portion of said crankshaft and said second end portion of said crankshaft.

65. The transmission device of claim 61, wherein said counterweight comprises a segmented disc shape.

66. The transmission device of claim 61, wherein said counterweight comprises an adjustable weight.

67. The transmission device of claim 61, wherein said counterweight comprises a solid member characterized by an absence of moving parts.

68. The transmission device of claim 1, wherein said connecting arm comprises at least one support projecting therefrom for use in moving the connecting arm along the journal portion.

69. The transmission device of claim 68, wherein said connecting arm comprises two supports.

70. The transmission device of claim 1, wherein said connecting arm comprises an opening for receiving said journal portion therethrough.

71. The transmission device of claim 70, wherein said connecting arm comprises at least one prong extending away from said opening.

72. The transmission device of claim 1, wherein said connecting arm is formed of separate pieces connected together at a joint.

73. The transmission device of claim 1, wherein said connecting arm comprises attachment means for attaching a foot.

74. The transmission device of claim 73, wherein said attachment means comprises a second opening.

75. The transmission device of claim 1, wherein said connecting arm is pivotally attached to a rack, and wherein said rack engages a pinion.

76. The transmission device of claim 75, further comprising a housing having a groove and said rack is confined to translational movement within said groove.

77. The transmission device of claim 75, further comprising a ball connection between the connecting arm and the rack for allowing multi-direction movement between the connecting arm and the rack.

78. The transmission device of claim 75, wherein said pinion is attached to an output shaft.

79. The transmission device of claim 1, wherein said connecting arm is attached to a chain, and wherein said chain engages a sprocket.

80. The transmission device of claim 79, wherein at least a portion of said chain is enclosed in a channel.

81. The transmission device of claim 1, further comprising a housing.

82. The transmission device of claim 1, further comprising a flex coupling.

83. The transmission device of claim 83, wherein said flex coupling is attached to the first end portion of the crankshaft.

84. The transmission device of claim 83, wherein the flex coupling comprises an inner portion and an outer portion.

85. The transmission device of claim 84, wherein the inner portion comprises a central opening for receiving the fist end portion of the crankshaft.

86. The transmission device of claim 84, wherein the outer portion comprises fastener holes for receiving fasteners to attach the flex coupling to the first rotational member.

87. The transmission device of claim 84, wherein the inner portion comprises tabs.

88. The transmission device of claim 87, wherein the outer portion comprises gaps for receiving the tabs in the inner portion.

89. The transmission device of claim 88, wherein flex coupling further comprises biasing means disposed between the tabs and the outer portion.

90. The transmission device of claim 1, wherein the transmission further comprises a counterbalance shaft.

91. The transmission device of claim 90, wherein the counterbalance shaft is configured to be approximately 180 degrees out of sequence with the crankshaft.

92. The transmission device of claim 90, wherein the counterbalance is driven by a chain attached to the crankshaft.

93. The transmission device of claim 90, wherein the counterbalance comprises an adjustable weight slidably disposed thereon.

94. The transmission device of claim 93, wherein the transmission further comprises a second guide for adjusting a position of the adjustable weight on the counterbalance.

95. The transmission device of claim 94, wherein the second guide is fixed to said guide.

96. The transmission device of claim 1, further comprising an input shaft and an output shaft.

97. The transmission device of claim 96, further comprising a second transmission for providing compression breaking.

98. The transmission device of claim 97, further comprising a second transmission input shaft connected to said output shaft.

99. The transmission device of claim 98, further comprising a second transmission output shaft connected to said input shaft.

100. The transmission device of claim 1, wherein said crankshaft further comprises a second journal portion.

101. The transmission device of claim 1, further comprising a second connecting arm disposed on said crankshaft.

102. The transmission device of claim 1, wherein said connecting arm is fixed against movement in a direction along said axis of rotation.

103. The transmission device of claim 1, wherein said crankshaft is configured to move in a direction along said axis of rotation.

104. The transmission device of claim 1, further comprising a spherical bearing disposed on said crankshaft between said connecting arm and said journal portion.

105. The transmission device of claim 1, wherein said angle is within a range of between approximately 0 degrees and approximately 90 degrees.

106. The transmission device of claim 105, wherein said angle is within a range of between approximately 5 degrees and approximately 20 degrees.

107. The transmission device of claim 106, wherein said angle is approximately 12 degrees.

108. The transmission device of claim 1, wherein said angle is within a range of between approximately 0 degrees and approximately 10 degrees.

109. The transmission device of claim 108, wherein said angle is approximately 5 degrees.

110. The transmission device of claim 1, wherein said angle is within a range of between approximately 10 degrees and approximately 20 degrees.

111. The transmission device of claim 110, wherein said angle is approximately 15 degrees.

112. The transmission device of claim 1, wherein said angle is within a range of between approximately 20 degrees and approximately 30 degrees.

113. The transmission device of claim 112, wherein said angle is approximately 25 degrees.

114. The transmission device of claim 1, wherein said angle is within a range of between approximately 30 degrees and approximately 40 degrees.

115. The transmission device of claim 114, wherein said angle is approximately 35 degrees.

116. The transmission device of claim 1, wherein said angle is within a range of between approximately 40 degrees and approximately 50 degrees.

117. The transmission device of claim 116, wherein said angle is approximately 45 degrees.

118. The transmission device of claim 1, wherein said angle is within a range of between approximately 50 degrees and approximately 60 degrees.

119. The transmission device of claim 118, wherein said angle is approximately 55 degrees.

120. The transmission device of claim 1, wherein said angle is within a range of between approximately 60 degrees and approximately 70 degrees.

121. The transmission device of claim 120, wherein said angle is approximately 65 degrees.

122. The transmission device of claim 1, wherein said angle is within a range of between approximately 70 degrees and approximately 80 degrees.

123. The transmission device of claim 122, wherein said angle is approximately 75 degrees.

124. The transmission device of claim 1, wherein said angle is within a range of between approximately 80 degrees and approximately 90 degrees.

125. The transmission device of claim 124, wherein said angle is approximately 85 degrees.

126. The transmission device of claim 1, wherein said journal portion has an oblong cross-sectional shape.

127. The transmission device of claim 1, wherein said journal portion has a triangular cross-sectional shape.

128. The transmission device of claim 1, wherein said journal portion has a square cross-sectional shape.

129. The transmission device of claim 1, wherein said journal portion has a rectangular cross-sectional shape.

130. The transmission device of claim 1, wherein said journal portion has an “I” shaped cross-section.

131. The transmission device of claim 1, wherein said second end portion comprises a non-coaxial end portion supported by a spherical bearing holding means.

132. The transmission device of claim 1, further comprising a braking means operatively attached to an output of said transmission.

133. The transmission device of claim 132, wherein said braking means comprises a hydraulically braking flywheel.

134. A transmission device comprising:
a crankshaft for attaching to a first rotational member, said crankshaft comprising a first end portion and a second end portion opposite said first end portion, said crankshaft further comprising a journal portion having a round cross sectional shape along a length thereof extending between said first end portion and said second end portion;
a connecting arm joined to said journal portion, said connecting arm configured to be movable along said length of said journal portion;
wherein an axis of rotation of said crankshaft extends in a direction from said first end portion to said second end portion and said journal portion extends at an angle with respect to said axis of rotation.

135. The transmission device of claim 134, further comprising means for adjusting a position of said connecting arm along said length of said journal portion.

136. The transmission device of claim 134, further comprising a second rotational member operatively connected to said connecting arm.

137. The transmission device of claim 134, wherein said crankshaft further comprises a counterweight for balancing said crankshaft when said crankshaft is rotated about said axis of rotation.

138. The transmission device of claim 134, further comprising unidirectional clutch means for converting oscillating movement into unidirectional rotation.

139. A transmission device comprising:
a crankshaft for attaching to a first rotational member, said crankshaft comprising a first end portion and a second end portion opposite said first end portion, said crankshaft further comprising a journal portion extending between said first end portion and said second end portion;
a connecting arm joined to said journal portion, said connecting arm having an opening for receiving said journal portion therethrough, said connecting arm configured to be movable along a length of said journal portion;
wherein an axis of rotation of said crankshaft extends in a direction from said first end portion to said second end portion and said journal portion extends at an angle with respect to said axis of rotation.

140. The transmission device of claim 139, further comprising means for adjusting a position of said connecting arm along said length of said journal portion.

141. The transmission device of claim 139, further comprising a second rotational member operatively connected to said connecting arm.

142. The transmission device of claim 139, wherein said crankshaft further comprises a counterweight for balancing said crankshaft when said crankshaft is rotated about said axis of rotation.

143. The transmission device of claim 139, further comprising unidirectional clutch means for converting oscillating movement into unidirectional rotation.

144. A transmission device comprising:
a crankshaft for attaching to a first rotational member, said crankshaft comprising a journal portion having a length extending along said crankshaft;
a connecting arm joined to said journal portion; and
a guide surrounding a portion of said journal portion, said guide having a chamber for receiving said connecting arm therein;
wherein said guide is configured to adjust a position of said connecting arm along said length of said journal portion to modify a ratio of movement between said first rotational member and a second rotational member.

145. The transmission device of claim 144, wherein said guide further comprises at least one slot for passing said connecting arm therethrough.

146. The transmission device of claim 144, further comprising at least one threaded rod for adjusting a position of said guide.

147. The transmission device of claim 144, wherein said crankshaft further comprises a counterweight for balancing said crankshaft when said crankshaft is rotated about said axis of rotation.

148. The transmission device of claim 144, further comprising unidirectional clutch means for converting oscillating movement into unidirectional rotation.

149. A method for modifying a ratio of movement between a first rotational member and a second rotational member, said method comprising the steps of:
(a) attaching a crankshaft to said first rotational member;
(b) attaching a connecting arm to said crankshaft and said second rotational member such that movement is transmitted from said first rotational member to said second rotational member when said first rotational member rotates;
(c) rotating said first rotational member; and
(d) moving said connecting arm along said crankshaft a distance spaced apart from said first rotational member.

150. The method of claim 149, wherein step (d) further comprises moving said connecting arm during rotation of said crankshaft.

151. The method of claim 149, wherein step (a) further comprises attaching said crankshaft to said first rotational member at an axis of rotation of said crankshaft.

152. The method of claim 149, further comprising placing the connecting arm along the axis of rotation to place the connecting arm in a neutral condition.

153. The method of claim 149, further comprising extending a bearing portion of the crankshaft at an angle with respect to the axis of rotation.

154. The method of claim 149, wherein step (b) further comprises encompassing a portion of said crankshaft with said connecting arm.

155. The method of claim 149, wherein step (b) further comprises passing said crankshaft through an opening in said connecting arm.

156. The method of claim 149, further comprising transmitting rotational movement of the first rotational member in one direction to rotational movement of the second rotational member in two directions.

157. The method of claim 156, further comprising converting the rotational movement of the second rotational member in two directions to a rotational output in a single direction.

158. A method for transmitting movement from a first rotational member to a second rotational member, said method comprising the steps of:
(a) attaching a crankshaft to said first rotational member;
(b) attaching a connecting arm to said crankshaft and said second rotational member such that movement is transmitted from said first rotational member to said second rotational member when said first rotational member rotates; and
(c) moving said connecting arm in three dimensions to modify a ratio of movement between said first rotational member and said second rotational member.

159. The method of claim 158, wherein step (c) further comprises moving said connecting arm during rotation of said crankshaft.

160. The method of claim 158, wherein step (a) further comprises attaching said crankshaft to said first rotational member at an axis of rotation of said crankshaft.

161. The method of claim 158, further comprising placing the connecting arm along the axis of rotation to place the connecting arm in a neutral condition.

162. The method of claim 158, further comprising extending a bearing portion of the crankshaft at an angle with respect to the axis of rotation.

163. The method of claim 158, wherein step (b) further comprises encompassing a portion of said crankshaft with said connecting arm.

164. The method of claim 158, wherein step (b) further comprises passing said crankshaft through an opening in said connecting arm.

165. The method of claim 158, further comprising transmitting rotational movement of the first rotational member in one direction to rotational movement of the second rotational member in two directions.

166. The method of claim 165, further comprising converting the rotational movement of the second rotational member in two directions to a rotational output in a single direction.

167. A transmission device comprising:
a crankshaft for driving a second rotational member through a connecting arm, said crankshaft comprising:
a first end portion for being attached to a first rotational member at an axis of rotation;
a second end portion opposite said first end portion;
a journal portion disposed between said first end portion and said second end portion, said journal portion configured for supporting said connecting arm;
wherein said crankshaft has a uniform cross-sectional shape along a length of said journal portion, and wherein said journal portion extends away from said axis of rotation such that when said connecting arm is moved along said journal portion, a ratio of movement between said first rotational member and said second rotational member is modified.

168. The transmission device of claim 167, wherein said crankshaft further comprises a collar disposed on said second end portion.

169. The transmission device of claim 167, wherein said crankshaft further comprises means for attaching said crankshaft to said first rotational member disposed on said first end portion.

170. The transmission device of claim 167, wherein said crankshaft further comprises a counterweight for balancing said crankshaft when said crankshaft is rotated about said axis of rotation.

171. A crankshaft for a transmission device, said crankshaft comprising:
a first end portion comprising a counterweight for balancing said crankshaft as said crankshaft is rotated about an axis of rotation;
a second end portion opposite said first end portion, said second end portion comprising a collar; and
a journal portion disposed between said first end portion and said second end portion, said journal portion having a length extending angularly with respect to said axis of rotation;
wherein said journal portion has a smaller crosssectional area than said counterweight and said collar, and
wherein said journal portion is configured to receive a connecting arm for transmitting movement from said first rotational member to a second rotational member.

172. The transmission device of claim 171, wherein said journal portion has a uniform cross-section along said length of said journal portion.

173. The transmission device of claim 171, wherein said crankshaft further comprises means for attaching said crankshaft to said first rotational member disposed on said first end portion.

174. A crankshaft for a transmission device, said crankshaft comprising:
a first end portion for attaching to a first rotational member at an axis of rotation;
a second end portion opposite said first end portion;
a journal portion disposed between said first end portion and said second end portion, said journal portion having a length extending angularly with respect to said axis of rotation;
wherein said journal portion has a split along said length for receiving connecting arm adjustment means therein, and wherein said journal portion is configured to support a connecting arm for transmitting movement from said first rotational member to a second rotational member.

175. The transmission device of claim 174, wherein said crankshaft further comprises a collar disposed on said second end portion.

176. The transmission device of claim 174, wherein said crankshaft further comprises means for attaching said crankshaft to said first rotational member disposed on said first end portion.

177. The transmission device of claim 174, wherein said crankshaft further comprises a counterweight for balancing said crankshaft when said crankshaft is rotated about said axis of rotation.

178. A transmission device comprising:
a crankshaft for attaching to a first rotational member at an axis of rotation, said crankshaft comprising a first end and a second end opposite said first end, and a journal portion extending along a length of said crankshaft between said first end and said second end;
a connecting arm inseparably attached to said journal portion and movable along said journal portion, said connecting arm configured to be lifted in a movement path by rotation of said crankshaft about said axis of rotation and to transfer movement to a second rotational member;
wherein movement of said connecting arm along said journal portion is configured to modify a ratio of movement between said first rotational member and said second rotational member.

179. The transmission device of claim 178, further comprising means for adjusting a position of said connecting arm along said length of said journal portion.

180. The transmission device of claim 178, further comprising a foot for attaching said connecting arm to said second rotational member.

181. The transmission device of claim 178, wherein said crankshaft further comprises a counterweight for balancing said crankshaft when said crankshaft is rotated about said axis of rotation.

182. The transmission device of claim 178, further comprising unidirectional clutch means for converting oscillating movement into unidirectional rotation.

183. A transmission device comprising:
a crankshaft for attaching to a first rotational member at an axis of rotation, said crankshaft comprising a first end portion and a second end portion opposite said first end portion, said crankshaft further comprising a journal portion having a length extending between said first end portion and said second end portion, said journal portion having a continuous cross-sectional shape along said length;
a connecting arm joined to said journal portion so as to encompass at least a portion of said journal portion, said connecting arm configured to be movable along said length of said journal portion and to be operatively connected to a second rotational member; and
means for adjusting a position of said connecting arm along said length of the journal portion;
wherein said axis of rotation of said crankshaft extends in a direction from said first end portion to said second end portion and said journal portion extends at an angle with respect to said axis of rotation such that when said connecting arm is moved along said journal portion, a ratio of movement between said first rotational member and said second rotational member is modified.

184. A transmission device comprising:
a crankshaft for attaching to a first rotational member at an axis of rotation, said crankshaft comprising a first end portion and a second end portion opposite said first end portion, said crankshaft further comprising a journal portion having a length extending between said first end portion and said second end portion, said journal portion having a continuous cross-sectional shape along said length;
a connecting arm joined to said journal portion so as to encompass at least a portion of said journal portion, said connecting arm configured to be movable along said length of said journal portion;
means for adjusting a position of said connecting arm along said length of the journal portion;
wherein said axis of rotation of said crankshaft extends in a direction from said first end portion to said second end portion and said journal portion extends at an angle with respect to said axis of rotation;
wherein said transmission device further comprises a second rotational member operatively connected to said connecting arm;
wherein said second rotational member comprises a splined shaft;
wherein said transmission device further comprises a gear portion disposed on said second rotational member;
wherein said transmission device further comprises an output gear in meshing engagement with said gear portion;
wherein said transmission device further comprises an output shaft disposed on said output gear;
wherein said transmission device further comprises unidirectional clutch means disposed on said output shaft;
wherein said unidirectional clutch means comprises a first unidirectional clutch and a second unidirectional clutch;
wherein said first unidirectional clutch comprises means for (i) engaging the output shaft in rotational movement when the second rotational member rotates in a first rotational direction and (ii) releasing the output shaft from engagement in rotational movement when the second rotational member rotates in a second opposing rotational direction;
wherein said second unidirectional clutch comprises means for (i) engaging the output shaft in rotational movement when the second rotational member rotates in the second rotational direction and (ii) releasing the output shaft from engagement in rotational movement when the second rotational member rotates in the first rotational direction;
wherein one of said first unidirectional clutch and said second unidirectional clutch is attached to reversing means for reversing the direction of rotational output;
wherein said means for reversing the direction of rotational output comprises a gear;
wherein said transmission device further comprises a foot pivotally attached to said connecting arm and fixedly attached to said second rotational member for transmitting movement of said connecting arm to said second rotational member;
wherein said foot comprises teeth configured for engaging with splines on the second rotational member;
wherein said means for adjusting a position of said connecting arm along said length of said journal portion comprises a guide for receiving said connecting arm;
wherein said guide comprises a sidewall defining a chamber for receiving said journal portion therethrough;
wherein said chamber is positioned in axial alignment with said axis of rotation;
wherein said sidewall comprises a plurality of slots for receiving said connecting arm therethrough;
wherein said means for adjusting a position of said connecting arm along said length of said journal portion further comprises at least one threaded rod for moving said guide;
wherein said guide further comprises at least one keeper for receiving said at least one threaded rod;
wherein said crankshaft further comprising means for attaching the crankshaft to the first rotational member disposed on said first end portion of the crankshaft;
wherein the means for attaching the crankshaft to the first rotational member comprises splines on the crankshaft;
wherein said crankshaft further comprises a collar disposed on said second end portion;
wherein said crankshaft comprises a counterweight disposed on said first end portion;
wherein said journal portion is configured such that said connecting arm is positionable on said journal portion at a neutral position on said axis of rotation such that said connecting arm does not transfer movement to said second rotational member when said connecting arm is in said neutral position;
wherein said connecting arm comprises at least one support projecting therefrom for use in moving the connecting arm along the journal portion;
wherein said connecting arm comprises an opening for receiving said journal portion therethrough;
wherein said connecting arm comprises at least one prong extending away from said opening;
wherein said connecting arm comprises attachment means for attaching said foot;
wherein said attachment means comprises a second opening;
wherein movement of said connecting arm along said journal portion is configured to modify a ratio of movement between said first rotational member and said second rotational member.

185. A transmission device comprising:
a rotational crankshaft having a journal portion disposed at a non-straight angle with respect to an axis of rotation of said crankshaft, said crankshaft being attachable to a first rotational member; and
a connecting arm attachable to a second rotational member and being disposed to encompass at least a portion of said journal portion, said connecting arm being movable along a length of said journal portion to thereby vary a ratio of movement of the first rotational member relative to the second rotational member, such that power is transferred from the first rotational member sequentially to the crankshaft, connecting arm and second rotational member when said first rotational member rotates.

186. A transmission device comprising:
a rotational crankshaft having a journal portion disposed at a non-straight angle with respect to an axis of rotation of said crankshaft, said crankshaft being attachable to a first rotational member; and
a connecting arm attachable to a second rotational member and being disposed to encompass at least a portion of the journal portion of the crankshaft, wherein said journal portion is movable with respect to said connecting arm to thereby vary a ratio of movement of the first rotational member relative to the second rotational member, such that power is transferred from the first rotational member sequentially to the crankshaft, connecting arm and second rotational member when said first rotational member rotates.
